(19) United States
(12) Patent Application Publication
(10) Pub. No.: US 2013/0307472 A1
(43) Pub. Date: Nov. 21, 2013

(54) STORAGE BATTERY INDUCTIVE CHARGING DEVICE

(71) Applicants: Marcin Rejman, Waiblingen (DE); Volker Amann, Augsburg (DE); Guenter Lohr, Leinfelden-Echterdingen (DE); Juergen Mack, Goeppingen (DE); Friederike Dietzel, Stuttgart (DE)

(72) Inventors: Marcin Rejman, Waiblingen (DE); Volker Amann, Augsburg (DE); Guenter Lohr, Leinfelden-Echterdingen (DE); Juergen Mack, Goeppingen (DE); Friederike Dietzel, Stuttgart (DE)

(73) Assignee: Robert Bosch GmbH, Stuttgart (DE)

(21) Appl. No.: 13/868,319

(22) Filed: Apr. 23, 2013

(30) Foreign Application Priority Data
Apr. 24, 2012 (DE) 10 2012 206 728.0

(51) Int. Cl. H02J 7/02

(52) U.S. Cl. CPC H02J 7/025
USPC 320/108

(57) ABSTRACT

A battery inductive charging device, e.g., a handheld tool battery inductive charging device for a motor vehicle, has at least one charging coil and an high-voltage energy input which is provided to take up a charging energy.

### BACKGROUND OF THE INVENTION

1. Field Of The Invention

The present invention relates to a battery inductive charging device.

2. Description Of The Related Art

A battery inductive charging device, e.g., a handheld tool battery inductive charging device for a motor vehicle, having at least one charging coil, has been proposed before.

### BRIEF SUMMARY OF THE INVENTION

The present invention relates to a battery inductive charging device, particularly an handheld tool battery inductive charging device for a motor vehicle, having at least one charging coil.

It is proposed that the battery inductive charging device have an high-voltage energy input, which is provided to take up at least a charging energy. By “motor vehicle” one should particularly understand at least a passenger car and/or a truck. The motor vehicle is preferably developed as an at least partially electric vehicle, but advantageously as an hybrid vehicle, as a fuel cell vehicle and/or as an electric vehicle. The motor vehicle preferably has an high-voltage battery, which at least partially drives the motor vehicle in at least one operating state. By a “charging coil” one should particularly understand a coil which receives charging energy during a charging process and/or transmits it. During a charging process, the charging coil of the battery inductive charging device preferably sends the charging energy to a charging coil of an handheld tool and/or advantageously of an handheld tool battery. The charging coil preferably includes at least one coil winding and particularly one coil core. Alternatively or in addition, the charging coil could be designed as an air coil. The charging coil is preferably developed as a printed circuit trace on a printed circuit board, or especially preferred as a wound coil.

By “handheld machine tool battery” one should particularly understand a battery pack provided to supply an handheld machine tool with energy, especially in case of a provided application. In a state ready for operation, the handheld tool battery pack is particularly connected to the handheld tool in a manner detachable without a tool being required. Alternatively or in addition, an handheld tool battery could be integrated into the handheld tool. A “handheld tool” should be understood in particular as a portable tool that appears practical to one skilled in the art, but preferably a drilling machine, a percussion drill, a saw, a plane, a screwdriver, a milling tool, a grinder, an angle grinder, a gardening device, a building site measuring device and/or a multifunctional tool.

By a “high-voltage energy input” one should particularly understand an interface provided to take up charging energy having a voltage greater than 30 Volt, advantageously greater than 60 Volt, particularly advantageously greater than 120 Volt. In particular, “provided” is to be understood as specially programmed, designed and/or equipped. By “charging energy” one should particularly understand energy which, during a charging process is transmitted by the charging coil inductively to a charging coil of the handheld tool battery.

The term “to take up” should be understood especially in that, during the charging process, at least the charging energy flows from the motor vehicle through the high-voltage energy input to the charging coil. Because of the design of the battery inductive charging device according to the present invention, an energy supply may be supplied having a particularly high efficiency and an advantageously high performance. Furthermore, one is able to do without a voltage transformation before the transmission to the battery inductive charging device.

In a further embodiment it is proposed that the battery inductive charging device include at least one voltage transformer that is provided to convert a voltage of charging energy that is present at the high-voltage energy input, whereby at least the charging coil is able to be supplied with an optimum voltage, which enables an advantageous embodiment of the charging coil. By a “voltage transformer” one should understand especially a unit provided to make available a voltage that is different from the voltage that is present at the high-voltage energy input. The voltage transformer preferably reduces the voltage present at the high-voltage energy input, namely, advantageously to less than 42 Volt, particularly advantageously to less than 24 Volt. As an alternative, a voltage transformer could transform a voltage of a charging energy present at an high-voltage energy input to an higher voltage than the one present at the high-voltage energy input, for instance, between 240 and 600 Volt.

The battery inductive charging device preferably has a voltage transformer, which provides an alternating voltage for supplying the charging coil. The battery inductive charging device advantageously has a voltage transformer which provides a direct voltage to supply the functional unit. The voltage transformer is preferably provided to make available a voltage present at the charging coil during a charging process, especially a variable voltage in a charging process. The voltage transformer is advantageously provided to make available a voltage for supplying a functional unit of the battery inductive charging device. The voltage transformer and the charging coil are preferably situated in the same battery inductive charging device housing. Alternatively, the voltage transformer and the charging coil could be situated in particularly non-destructively separable housings. By a “voltage present” one should particularly understand an electrical potential difference between two contacts of the high-voltage energy input, at least during the charging process.

Furthermore, it is proposed that the battery inductive charging device have a functional unit provided at least to control the at least one charging process of the charging coil, which makes possible a charging process adapted to an operating state. By “functional unit” one should particularly understand a unit having an information input, information processing and an information output. The functional unit preferably has at least one arithmetic unit. Alternatively or additionally, the functional unit could have a switching circuit, particularly an analog one, that would appear meaningful to one skilled in the art. The arithmetic unit advantageously has at least one processor, a memory, input and output means, an operating program, regulating routines, control routines and/or calculating routines. The functional unit is preferably developed as a microcontroller. By a “charging process” one should particularly understand a process in which the charging coil transfers a charging energy to the handheld tool battery, and the handheld tool battery stores the charging energy. By “at least to control” one should particularly understand controlling and/or regulating.

It is further proposed that the battery inductive charging device have a communications interface, which in at least one operating state receives at least one energy availability information, particularly from the motor vehicle, whereby one is able to achieve a particularly advantageous protection of an energy source, especially of an high-voltage battery of the motor vehicle. A “communications interface” is to be understood in particular as an interface provided advantageously at least to receive digitally coded information. Alternatively or additionally, the interface could receive analog coded information. The communications interface is developed as a particularly wire-bound communicating interface appearing meaningful to one skilled in the art, but advantageously as a CAN interface, a LIN interface and/or a FlexRay interface. Alternatively or in addition, the communications interface location has a wireless communicating interface, for instance, a Bluetooth interface and/or a Zigbee interface. The communications interface is preferably provided to communicate via an electrical conductor, which supplies the battery inductive charging device at least with electric charging energy.

By “energy availability information” one should particularly understand a characteristic quantity which has at least information on the quantity of energy that is retrievable by the motor vehicle. The energy availability information preferably has information on the quantity of energy stored by a battery of the motor vehicle. The energy availability information could, for example, be a function of a voltage of the battery of the motor vehicle. The energy availability information advantageously has information on electric power generated by, and/or available to the motor vehicle. The energy availability information particularly has at least one information on other users supplied with electric power by the motor vehicle, such as a light or an air conditioning system of the motor vehicle. The energy availability information has information, for example, as to whether an internal combustion engine of the motor vehicle is in operation. The energy availability information is preferably a function of the operating state of the motor vehicle. The energy availability information could, for instance, be a function of whether the ignition of the motor vehicle is switched on.

In addition, it is provided that the functional unit be provided to control the charging process as a function of the energy availability information, whereby, in response to an advantageous protection of the high-voltage battery of the motor vehicle, an optimal charging process is able to be achieved. By the expression “to control as a function of at least one energy availability information” one should understand that the functional unit determines the power transmitted and/or advantageously the quantity of energy during a charging process, based on the energy availability information. The functional unit is preferably provided to charge the handheld tool battery up to a charging state as a function of the energy availability information, for example, to charge it half full.

Furthermore, it is proposed that the functional unit is provided to control the charging process as a function of a voltage present at the high-voltage energy input, whereby an advantageous protection of the motor vehicle is able to be achieved using low constructive expenditure.

In one advantageous development of the present invention, it is proposed that a battery inductive charging device include filtering means provided to minimize the output of at least one signal at least having an inductive charging frequency via the high-voltage energy input, particularly to the motor vehicle, whereby interference of the electronic system of the motor vehicle is avoided and the battery inductive charging device is advantageously able to be protected from damage by voltage fluctuations. By “filtering means” one should particularly understand a filter that appears meaningful to one skilled in the art, preferably, however, a filter having at least one coil, a ferrite and/or advantageously a capacitor. The filtering means are advantageously provided to filter out common mode interferences or push-pull interferences. The filtering means are preferably developed as a low-pass filter. By the expression “to minimize the output of at least one signal” one should understand that the filtering means reduce the effect on the voltage present at the high-voltage energy input. The filtering means preferably reduce an effect on the voltage present at the high-voltage energy input, at least at the inductive charging frequency.

Furthermore, it is proposed that the battery inductive charging device have a carrying case holding device that is provided to fasten an handheld tool carrying case in a carrying case accommodation region, whereby the at least one handheld tool battery is able to be fastened particularly conveniently in the motor vehicle for charging using the battery inductive charging device. The carrying case holding device preferably has at least one fastening means that appears meaningful to one skilled in the art, but preferably a snap-on means. By “handheld tool carrying case” one should particularly understand a carrying case provided to accommodate at least one handheld tool battery. The handheld tool carrying case preferably includes the handheld tool battery in at least one form-locking and/or force-locking manner. The handheld tool carrying case preferably fastens the handheld tool battery in an immovable manner. One should particularly understand by “carrying case accommodation region” the region the handheld tool carrying case fills up in a fastened state. The carrying case holding device preferably borders on the carrying case accommodation region on at least one side. Alternatively or in addition, the battery inductive charging device could have an holster and/or a shelf for the direct or indirect fastening of the handheld tool battery.

Moreover, it is proposed that the charging coil, in at least one operating state, charge an handheld tool battery situated in the carrying case accommodation region, whereby taking out the handheld tool battery from the handheld tool carrying case to charge the handheld tool battery is omitted. By the expression “situated in the carrying case accommodation region” one should understand that the handheld tool battery is situated in the handheld tool carrying case during the charging process, which is fastened in the carrying case accommodation region of the carrying case holding device.

### BRIEF DESCRIPTION OF THE DRAWING

FIG. 1 schematically shows a motor vehicle and a system having a battery inductive charging device according to the present invention.

### DETAILED DESCRIPTION OF THE INVENTION

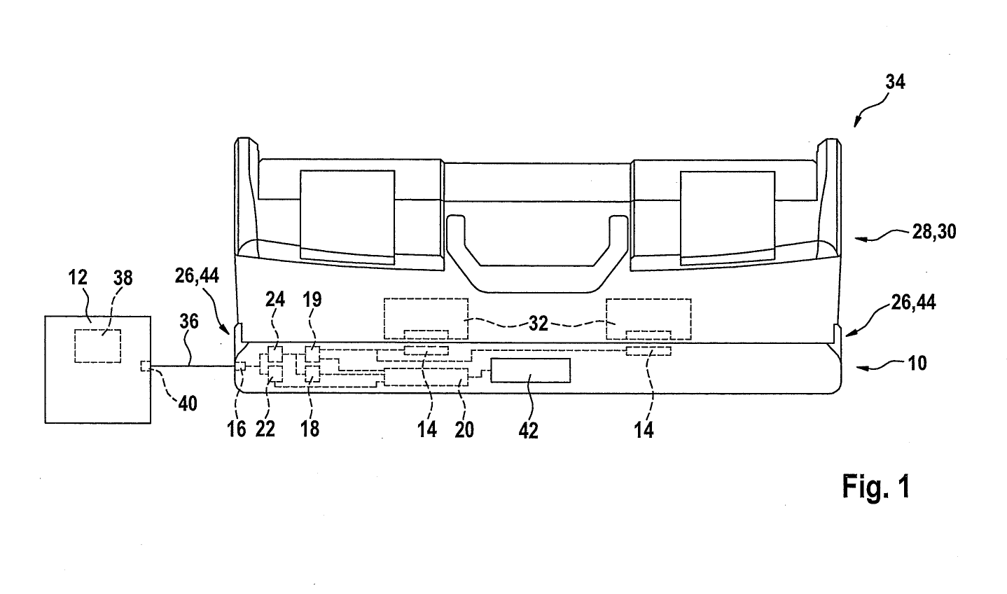

FIG. 1 schematically shows a motor vehicle 12 and a system 34 having a battery inductive charging device 10, a handheld tool carrying case 28, two handheld tool batteries 32 and a motor vehicle interface 36. Motor vehicle interface 36 connects battery inductive charging device 10 to motor vehicle 12.

Motor vehicle 12 has an high-voltage battery 38 which, in at least one operating state, provides energy for moving motor vehicle 12. Battery inductive charging device 10 is provided to be fastened in an internal space of motor vehicle 12. Alternatively or additionally, a battery inductive charging device could be provided to be situated and advantageously fastened on a front passenger seat and/or on a loading area of a motor vehicle. Motor vehicle 12 has an high-voltage energy output 40. At high-voltage energy output 40, motor vehicle 12 provides a direct voltage at 120 Volt. Alternatively or in addition, a motor vehicle could provide an alternating voltage and/or a voltage having a different value.

Battery inductive charging device 10 has two charging coils 14, an high-voltage energy input 16, two voltage transformers 18, 19, a functional unit 20, a communications interface 22, a filtering means 24 and an operator interface 42. High-voltage energy input 16 takes up at least charging energy during a charging process. For this, high-voltage energy input 16 has an embodiment that is adjusted to the voltage that the motor vehicle provides. High-voltage energy input 16 is electrically connected to communications interface 22 and filtering means 24. Functional unit 20 is provided to communicate with motor vehicle 12 via communications interface 22. Communications interface 22 receives energy availability information from motor vehicle 12 before a charging process.

Filtering means 24 has a low-pass filter. Filtering means 24 minimizes the transmission of electromagnetic interferences to motor vehicle 12. In addition, filtering means 24 is provided especially to minimize an output of at least one signal having at least an inductive charging frequency via high-voltage energy input 16. Filtering means 24 is designed as a band elimination filter. For this purpose, filtering means 24 has a band elimination filter having an average frequency corresponding to the inductive charging frequency.

Filtering means 24 is connected to the two voltage transformers 18, 19. The first voltage transformer 18 provides a voltage to supply functional unit 20. The second voltage transformer 19 provides two charging voltages to supply the two charging coils 14. Second voltage transformer 19 is developed to be controllable by functional unit 20. Functional unit 20 is provided to control the charging process via the second voltage transformer 19 as a function of the energy availability information. Voltage transformers 18, 19 are provided to transform a voltage of the charging energy present at high-voltage energy input 16. First voltage transformer 18 reduces the voltage of the charging energy that is present at high-voltage energy input 16 to a lower direct voltage, in this case, 5 Volt. Second voltage transformer 19 reduces the voltage of the charging energy that is present at high-voltage energy input 16 to a lower alternating voltage, which is a function of a charging power. A sensor is not shown in greater detail, via which functional unit 20 measures the voltage present at high-voltage energy input 16. If the voltage present at high-voltage energy input 16 falls below a configurable value, functional unit 20 terminates the charging process. Consequently, functional unit 20 is provided to control the charging process as a function of a voltage present at high-voltage energy input 16.

Operator interface 42 shows the operator a charging state of handheld tool batteries 32, at least during a charging process.

Furthermore, the charging process of handheld tool batteries 32 is configurable via operator interface 42. Functional unit 20 is provided to actuate operator interface 42 to indicate the charging state. Moreover, functional unit 20 is provided to plan the charging process via operator interface 42, with the aid of the operator input. Alternatively or additionally, functional unit 20 could be provided to plan the charging process automatically.

Battery inductive charging device 10 has carrying case holding device 26, which is provided to fasten handheld tool carrying case 28 in a carrying case accommodation region 30. For this, carrying case holding device 26 includes two holding means 44, which latch handheld tool carrying case 28 at least during a charging process in carrying case accommodation region 30. Handheld tool carrying case 28 and/or an inlay of handheld tool carrying case 28, not shown in greater detail, during a charging process, positions handheld tool batteries 32 to border upon charging coils 14 of battery inductive charging device 10. During the charging process, charging coils 14 charge handheld tool batteries 32 that are situated in carrying case accommodation region 30. In this process, handheld tool batteries 32 remain in handheld tool carrying case 28.

What is claimed is:

1. A handheld tool battery inductive charging device for a motor vehicle, comprising:
at least one charging coil; and
a high-voltage energy input configured to take up charging energy.

2. The battery inductive charging device as recited in claim 1, further comprising:
at least one voltage transformer configured to transform a voltage of the charging energy present at the high-voltage energy input.

3. The battery inductive charging device as recited in claim 2, further comprising:
a functional unit configured to control a charging process of the charging coil.

4. The battery inductive charging device as recited in claim 3, further comprising:
a communications interface which, in at least one operating state, receives at least one energy availability information.

5. The battery inductive charging device as recited in claim 4, wherein the functional unit controls the charging process as a function of the energy availability information.

6. The battery inductive charging device as recited in claim 3, wherein the functional unit controls the charging process as a function of a voltage present at the high-voltage energy input.

7. The battery inductive charging device as recited in claim 3, further comprising:
a filtering element which minimizes an output of at least one signal having an inductive charging frequency via the high-voltage energy input.

8. The battery inductive charging device as recited in claim 3, further comprising:
a carrying case holding device which fastens a handheld tool carrying case in a carrying case accommodation region.

9. The battery inductive charging device as recited in claim 8, wherein the charging coil, in at least one operating state, charges a handheld tool battery situated in the carrying case accommodation region.

10. A system comprising:
at least one handheld tool battery; and
a battery inductive charging device including:
at least one charging coil;
a high-voltage energy input configured to take up charging energy;
at least one voltage transformer configured to transform a voltage of the charging energy present at the high-voltage energy input;
a functional unit configured to control a charging process of the charging coil; and
a communications interface which, in at least one operating state, receives at least one energy availability information;
wherein the functional unit controls the charging process as a function of the energy availability information.
